(19) United States
(12) Patent Application Publication
(10) Pub. No.: US 2005/0144462 A1
(43) Pub. Date: Jun. 30, 2005

(54) Triple length passwords composed of memorizeable synthetic and natural pronounceable words

(76) Inventor: Victor Justin LaGarde, Keller, TX (US)

Correspondence Address: Justin LaGarde, 8628 Shadow Trace Dr., Keller, TX, 76248, US

(21) Appl. No.: 10/746,650

(22) Filed: Dec. 29, 2003

(51) Int. Cl. H04K 1/00

(52) U.S. Cl. 713/184

(57) ABSTRACT

This paper introduces a design of a longer than normal, vastly more secure, password, which is composed of smaller pronounceable words, enabling the password to be easily memorized. The password is actually a pass phrase, or pass sentence. This pass phrase may be composed of English dictionary words, words not in the dictionary, or even computer generated, synthetic (but still pronounceable) words.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF THE INVENTION

This invention pertains to the field of electrical computers and digital processing systems support/password (Classification 713/202).

Over the millennia, passwords and pass phrases have been used to gain entry to restricted areas, and in the last half century, computers. With the advances in computing power, the passwords of today, typically six to eight characters, offer an increasingly lower amount of security. Until now, the barrier to longer passwords has been the difficulty in memorization. This paper advances the idea of an eighteen digit (roughly triple length) password composed of smaller, pronounceable, words—a pass phrase, if you will. Furthermore, it can be mathematically proven that an expected application of the new password, compared to a typical application of the old password, has about five billion times as many combinations (it is vastly more secure). This generation of of pass phrases from English dictionary words, words not in the English dictionary, and synthetic words is the primary claim of this patent. A search of patents with the words “password” and “synthetic” in the title was made, back to 1976 (before the advent of personal computer hardware and software utilized in the creation of this invention). A second search for the words “computer” and “generated” and “password” and “sentence” was performed. No similar claims were found.

### BRIEF SUMMARY

Natural English words are largely composed of vowels, consonants, and digraphs or blends. A computer program was made to produce synthetic pronounceable words using these building blocks. The idea was that pronounceable words are easy to memorize.

Another computer program was designed to pseudo-randomly select two four letter words and two five letter words to compose an eighteen digit password (or pass phrase). Several word lists were formed to serve as the underlying data for this computer program:
1. a list of four letter and five letter words in a common English pocket dictionary
2. a list of four letter and five letter words NOT found in a common English pocket dictionary. This included place names, proper names, and words in foreign dictionaries (Spanish, Italian, German, and French)
3. A list of synthetic pronounceable four and five letter words, obtained from the computer program described above.

A computer program was also developed to form pass sentences (with syntax noun-verb-adjective-noun) from foreign words.

### BRIEF DESCRIPTION OF THE SEVERAL VIEWS OF THE DRAWING

NOT APPLICABLE

### DETAILED DESCRIPTION OF THE INVENTION

Longer passwords are more secure, as there are more possible permutations. For example, a four digit numerical PIN has 10\hat{ }4 possible combinations, while an eighteen digit case-sensitive alpha-numeric password has 62\hat{ }18=1.83×10\hat{ }32 possible combinations. However, the latter password would most likely be quite cumbersome to use in all of its combinations, since most of them would be unpronounceable and unmemorizeable for most of us. This invention demonstrates that there is middle ground, but much higher than the current passwords of six to eight characters.

If this key were an easily memorized phrase, composed of four smaller words (of length four or five characters), there are approximately 16×10\hat{ }12 possibilities (there being, in round numbers, 2000 common four-letter words and 2000 common five-letter words). One example of this type of 18 digit key is “looselipssinkships”. Of course, the introduction of numerals and words not in the dictionary (proper names, place names, foreign words, etc.) increases the number of possible keys, e.g. “ubereigen2506henri”, “babar9802sanssouci”, “eulergammaquidvici”, etc.

The following paragraphs demonstrate the method and computer programs used in composing an 18 digit memorizeable pass phrase.

1. Examination of the English Language

A common pocket dictionary of the English language, Merriam-Webster, was used to identify (2210) four letter words and (2738) five letter words. These words can be joined together in several configurations to form a pass phrase. The configurations are 4-5-5-4, 4-4-5-5, 5-5-4-4, 4-5-4-5, 5-4-5-4, 5-4-4-5. There are approximately (2210×2738)\hat{ }2=3.66×10\hat{ }13 possibilities. This is for natural English words, a subset of the synthetic words developed in the next section. English four and five letter words are composed of vowels, consonants, and digraphs or blends. There are both beginning and ending digraphs (they begin or end a word). These vowels, consonants, and digraphs were identified as follows:
There are (5) vowels (y was omitted due to ambiguous pronunciations).
There are (18) consonants (q, y, and x were omitted due to ambiguous pronunciations).
There are (27) beginning digraphs and (42) ending digraphs used in this invention.

Four letter words may be made from two sequences of components, beginning digraph-vowel-consonant (2430 possibilities), and consonant-vowel-ending digraph (3780 possibilities) (total of 6210 synthetic four letter words). Five letter words may be made from the sequence beginning digraph-vowel-ending digraph (5670 possibilities).

2. Computer Program to Make Synthetic Words

Data files containing (separate) lists of vowels, consonants, beginning digraphs, and ending digraphs were formed. The computer program, performed in Fortran, inducts these data files into arrays. Through a series of nested “do loops” the synthetic words are formed and output to a data file. Three computer programs were created, one for each configuration of synthetic word. The first ten words produced by each computer program are shown below:
blab, blac, blad, blaf, blag, blah, blaj, blak, blal (words 11 thru 2430 omitted for brevity)
bach, cach, dach, fach, gach, hach, jach, kach, lach, mach (words 11 thru 3780 omitted for brevity)
blach, brach, chach, clach, crach, drach, flach, frach, glach, grach (words 11 thru 2700 omitted for brevity, note that there are actually 5670 possibilities but a stack overflow situation occurred beyond 2700 words)
   3. Search for Words not in the English Dictionary

Words not in the English dictionary are thought to promote security of a password. Swiss and UAE place names were obtained from the NIMA Geonet names server. Proper names were obtained from Babynames.com. Foreign language words (Spanish, Italian, German, and French) were obtained from Berlitz reference dictionaries.

4. Computer Program to Make Pass Phrase from English Dictionary Words

Data files were made containing four and five letter words from the English dictionary. These were inducted into the program as arrays. The user inputs a nine digit arbitrary number. The number is reduced modulo X, where X is the record length of the word array. One is added to this, and this becomes a pseudo-random pointer, choosing a word. This is done another three times, until four words are picked. These are assembled and displayed on the monitor. There are (2210×2738)\hat{ }2=3.66×10\hat{ }13 possibilities here. If one of the five digit words was removed, and a five digit number substituted, the number of possibilities would be 2210×2738×2210×100000=1.34×10\hat{ }15. This is a reasonable expectation for the practical use of the invention, and it will form the basis for a performance comparison later. Five results from this program are listed below (read in five columns):
Input Output
123123123 druid stag lick yearn
123456789 bully snip lamb taste
741852963 along bite rote shrug
888444888 stake fall vein midge
528528528 marry daft swig dinky
   5. Computer Program to Make Pass Phrase from Words not in the English Dictionary

Using the data gathered in paragraph 3, a similar computer program was made.

Here there are (1564×2820)\hat{ }2=1.94×10\hat{ }13 possibilities.

Examples of input and output:
777777777 zenon gure kern lajos
258258258 samen reif dave tudor
369369369 laret toby amor andau
159159159 kamea adem ursa sahil
9012390123 dunne ahle dore fusio
   6. Computer Program to Make Synthetic Sentence From Foreign Words

Using the data gathered in paragraph 3, a similar computer program was made.

The sentence configuration 4 noun-5 verb-4 adjective-5 noun was used.

Here there are (1262×338×254×2440)=2.64×10\hat{ }11 possibilities.

Examples of input and output:
123123122 raja casar vide colpo
777888999 mayo minar hart traje
848484565 tube meler bleu pacha
555555555 muso taire pale cerdo
222333111 popo faire ubel lepra
   7. Computer Program to Make Synthetic Pass Phrase from Synthetic Words

Using the synthetic words generated in paragraph 2, a computer program similar to the other pass phrase generators was made. Here there are (5705×2700)\hat{ }2=2.37×10\hat{ }14 possibilities. Were it not for the stack overflow problem, there would be (6210×5670)\hat{ }2=1.24×10\hat{ }15 possibilities.

Five of these possibilities are:

| | |
|---|---|
| 427428429 | shing dunt gils smuls |
| 888888881 | phact papt solt pring |
| 867310999 | sluld hoct swek snech |
| 000555000 | shalt smus griv smild |
| 422876137 | crund rard tomn flels |

8. Manual Generation of Pass Phrase

Last, but not least, there are an unknown number of possibilities for generating 18 digit pass phrases manually. Eighteen are given below:

```
  1. DONEONCEFANCYTHING
  2. DONEMANYTIMESKNOT
  3. TEENEIGHTTEENEIGHT
  4. HELLOBILLHIGHTHERE
  5. SWANKCODEBEATSTHIS
  6. LASTTRAIN4THECOAST
  7. NIGHTTRAINFASTCOAL
  8. SHAKYLEGSKNEWFOAL
  9. DALEDAVISISLECAPRI
10. RICEARONIFRANTREAT
11. FORDCARSARENTROUGE
12. LARGESHIPGEAUXSLOW
13. LASTCARS2PASSRADAR
14. JINGOLINGOHAVENICE
15. 33480BLACKMERCCARS
16. 60606WHITEEASTDIME
17. 1492SAILSOCEANBLUE
18. EIGHTEENX18181818
```

In this category of manually generated pass phrases, almost anything can be used—zip codes, song lyrics, license plate numbers, etc.

9. Performance Comparison

Today's passwords are typically six to eight characters; many people use a five letter word followed by two numerals. This password would have 2738×100=2.74×10\hat{ }5 possibilities. Compare to the results of the program in paragraph 4, the one using English dictionary words, but with one of the four words replaced by numerals. It had 1.34×10\hat{ }15 possibilities. The computer program using synthetic words also is of the same magnitude, even without using numerals at all, or being case sensitive, for that matter. Dividing the two figures of 1.34×10\hat{ }15 and 2.74×10\hat{ }5, one finds that the 18 character pass phrase differs by a factor of 4.89×10\hat{ }9, or, put another way, is almost 5 billion times stronger (has 5 billion times as many permutations). A billion is a kilo-Giga, and that's a lot. In closing, a four word pass phrase is just as memorizeable as a word and two digits, but it's better.

1. This invention is that of a “triple length”, computer generated password or pass phrase, designed to be memorizeable through the use of a number of smaller pronounceable words. This method produces a typical pass phrase that has five billion times more possible combinations than the typical password of today. This method of constructing a pass phrase constitutes claim one.

2. English words are largely composed of vowels, consonants, and digraphs or blends. These constituents may be assembled by a computer, forming synthetic pronounceable words. This computerized assembly method constitutes claim two.
